(19) United States
(12) Patent Application Publication
(10) Pub. No.: US 2005/0117220 A1
(43) Pub. Date: Jun. 2, 2005

(54) Projection display system

(75) Inventors: Adrianus Johannes Stephanes Maria De Vaan, Eindhoven (NL); Stephen Charles McClain, Eindhoven (NL)

Correspondence Address: Corporate Patent Counsel;Philips Electronics North America Corporation, P O Box 3001, Briarcliff Manor, NY, 10510, US

(73) Assignee: Koninklijke Philips Electronics N.V., Eindhoven (NL)

(21) Appl. No.: 10/498,754

(22) PCT Filed: Nov. 26, 2002
(86) PCT No.: PCT/IB02/04995

(30) Foreign Application Priority Data
Dec. 18, 2001 (EP) 01204953.2

(51) Int. Cl. G02B 5/30

(52) U.S. Cl. 359/501; 359/495

(57) ABSTRACT

A liquid crystal display system comprising: a. a dichroic mirror (2) arranged to direct first and second spectral components along a first processing path (A) and to direct a third spectral component along a second processing path (B); b. a first cubic polarizing beam splitter (4) arranged to direct the first and second components towards first and second liquid crystal on silicon (LCoS) panels (18, 22), respectively, and to direct the first and second components, after modulation, along a third processing path (C); c. a second cubic polarizing beam splitter (6) arranged to direct the third component towards a third LCoS panel (28), and to direct the third component, after modulation, along a fourth processing path (D); d. a cubic dichroic beam splitter (8) arranged to direct said first and second components and said third component along a fifth processing path (E); and e. three post analyzers (30, 32, 34) arranged on an external output face of the dichroic beam splitter.

This invention relates to a projection display system, in particular a color projection display system.

Liquid crystal projection display systems are known. Liquid crystal on silicon (LCoS) display panels are used to separately modulate three different spectral components (red, green, blue) of a white light beam, and the three components are combined to form the output beam which is projected on a display screen. LCoS projection display systems have the advantage of a relatively high resolution at relatively low cost. Such systems are proposed for use in products such as large-screen desktop computer monitors, high-definition television (HD-TV) and high-resolution front projectors.

Various systems are known and proposed for use in separating the white light from the light source into the three separate components, and to recombine the beams after being modulated by the display panels. One example uses cubic beam splitters and polarization optics in order to perform the separating and recombining operations. Such a system is described, for example, in European Patent Application EP-A-1081964. The polarizing beam splitters separate the light into its separate components and analyze desired parts of the three different components of the beam. In order to enhance contrast in the image produced, plate analyzers, in the form of polarizers, are placed between the cubic beam splitters, to additionally analyze the beams, and thereby enhance contrast. These analyzers generate heat within the system. Therefore, if the arrangement is used at high brightness levels, problems such as thermal degradation of the analyzers and thermally induced stress birefringence appearing in the beam splitter cubes occur within the system.

It is an object of the present invention to provide a projection display system capable of operating at high brightness levels whilst providing improved contrast in the output image.

In accordance with the present invention, there is provided an optical device for processing radiation, said device comprising:
a radiation input means arranged to direct first and second spectral components along a first processing path and to direct a third spectral component along a second processing path;
b. first polarization-selective reflective means arranged to reflect the first spectral component and the second spectral component selectively in dependence on polarization states thereof, to direct said first and second components towards first and second radiation modulation means, respectively, for modulation thereby and to direct the first and second components, after modulation, along a third processing path, said first and second components having different polarization states when travelling along said third processing path;
c. second polarization-selective reflective means arranged to reflect the third component selectively in dependence on a polarization state thereof, to direct said third component towards third radiation modulation means, for modulation thereby and to direct the third component, after modulation, along a fourth processing path;
d. spectrally selective reflective means arranged to process said first and second spectral components similarly when in different polarization states, and arranged to direct said first and second components and said third component along a fifth processing path; and
e. radiation output means arranged to process radiation along said fifth processing path, said output means including spectrally selective polarization-sensitive means arranged to process said first and second components differently when in different polarization states.

By using the spectrally selective reflective means arranged to process the first and second components similarly when in different polarization states, and the spectrally selective polarization-sensitive means arranged to process the first and second components differently when in different polarization states, the use of analyzers between the reflective elements can be avoided. An output analyzer can be placed on an external face of the device, thereby improving contrast whilst avoiding excessive heating of the device between the reflective elements when operating at high brightness levels.

Further features and advantages of the invention will become apparent from the following description of preferred embodiments of the invention, given by way of example only, made with reference to the accompanying drawings, wherein:

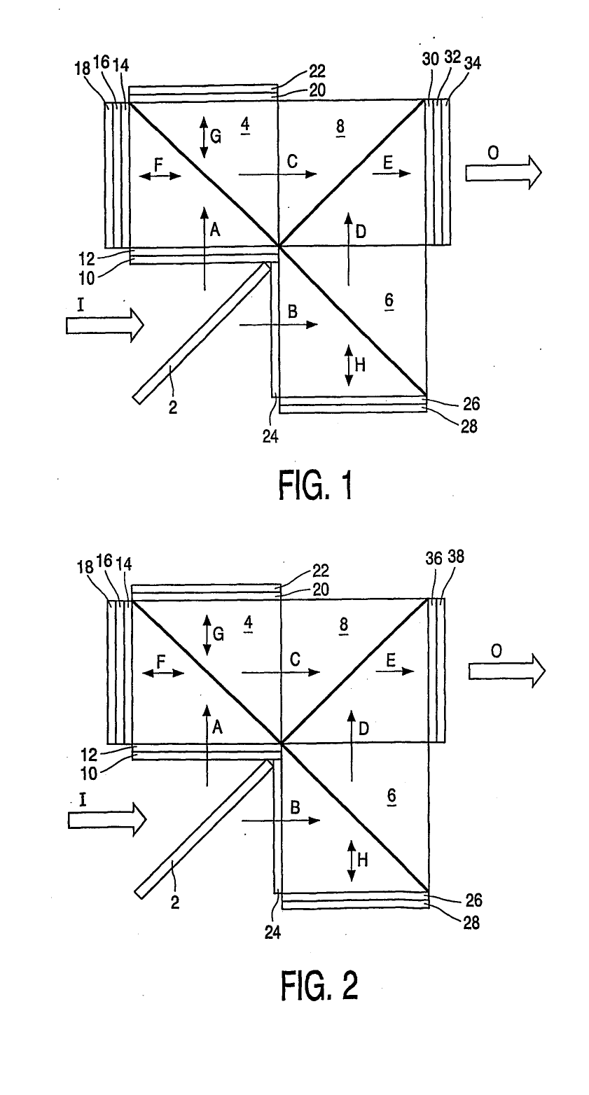

FIG. 1 is a cross-sectional view of a liquid crystal projection display device in accordance with an embodiment of the invention; and

FIG. 2 is a cross-sectional view of a liquid crystal projection display device in accordance with another embodiment of the invention.

FIG. 1 shows a liquid crystal projection display device in accordance with an embodiment of the invention. A colour video display system in accordance with this embodiment of the invention includes the display device along with a radiation source, not shown, emitting substantially white light in the form of an input beam (I) and further optical components, not shown, typically including a magnifying output lens for projecting an output beam (O), and a projector screen for displaying the video image. The colour modulation device includes elements for separately modulating different spectral components, each covering substantially exclusive wavelength ranges in the visible spectrum, of the radiation beam, typically red, green and blue components.

A spectrally-selective reflection element, in the form of a dichroic mirror 2, is arranged at 45° to the input beam I. The mirror acts as a beam splitter, splitting the input beam into different components travelling along two orthogonal processing paths A and B. First and second components of the radiation beam travel along the first processing path A into a cubic polarizing beam splitter 4, whereby the two components are separated and subsequently combined after separate modulation. After separate modulation, the two components are projected along a third processing path C towards a cubic dichroic beam splitter 8, through which the two components are transmitted.

A third component of the radiation beam travels along the second processing path B into cubic polarizing beam splitter 6, whereby the third component is projected for modulation. The third component is then projected along a fourth processing path D into dichroic beam splitter 8, where the third component is reflected through 90° and thereby combined with the first and second components and projected along a fifth processing path E towards an output path of the device.

In the first processing path A, the two beam components are subject to optical processing before entering the cubic beam splitter 4. A polarizer 10 cuts out all polarization components except for a single linear polarization component of the spectrally-filtered input beam. The input beam I itself is preferably substantially polarized, with the polarizer 10 being arranged with its axis of polarization parallel to that of the input beam.

A spectrally selective retardation plate 12 is used to selectively rotate the polarization state of one of the two components travelling on the first processing path A. The retardation plate 12 could be of the type which is available from the company ColorLink Inc, Boulder, Colo.

As a result of the selective retardation of one of the components of the beam, one of the components is reflected by the polarizing beam splitter 4 whereas the other is transmitted on the basis of the difference in polarization states.

The first spectral component travels along a first separate processing path F towards elements at which the beam component is modulated with the appropriate part of the image signal. The first component is processed using a bandpass filter 14, a skew angle compensator in the form of a quarterwave plate 16 and a liquid crystal on silicon (LCoS) light modulation panel 18 which selectively modulates the polarization state of different parts of the first component on reflection in accordance with an applied first colour component of the image signal. Selected, desired, parts of the component beam, distributed across the surface of the LCoS panel 18, have their polarization state rotated through 90° on reflection, whilst the remaining parts remain unaffected on reflection. The desired parts are transmitted through the polarization beam splitter C, whilst the unwanted parts are reflected back towards the input light source. Thus, the polarizing beam splitter 4 acts as a first-stage analyzer for the first component beam following its modulation by the LCoS panel 18. Since the polarizing beam splitter 4 is located immediately adjacent the LCoS panel 18 and its associated laminar components 14, 16, a relatively high degree of contrast is obtained during the first analyzing stage.

The second radiation component, which is transmitted through the polarizing beam splitter 4, travels along a second separate processing path G to be separately modulated. A skew angle compensator 20 in the form of a quarterwave plate processes the beam before the beam reaches a second LCoS panel 22, at which the beam is modulated in polarization in accordance with a second colour component image signal. On reflection from the LCoS panel 22, the desired parts of the beam, which are rotated through 90° at the LCoS panel 22, are reflected by polarizing beam splitter 4 to join the desired parts of the first beam component along the third processing path C. Again, polarizing beam splitter 4 acts as a first-stage analyzer for the second beam component. However, since the polarizing beam splitter 4 analyzes the second component by reflection, the analyzing of the second component is less efficient than that of the first component, which is analyzed in transmission through the polarizing beam splitter 4.

The bandpass filter 14 is used to spectrally purify the first component of the beam and is provided in the first separate processing path F, while no such bandpass filter is provided to process the second component, because the polarization-selective effect of the polarizing beam splitter 4, which is used to provide the spectral separation in combination with the spectrally selective retardation plate 12, is more efficient in transmission than in reflection.

Since the second polarizing beam splitter 6 is located immediately adjacent the third LCoS panel 28 and its associated laminar element 26, the second polarizing beam splitter 6 performs first-stage analyzing of the reflected beam, to thereby provide a relatively high degree of contrast in the beam directed along the fourth processing path D.

Polarizer 24 is provided in the second processing path B to polarize the third radiation component before entering the second polarizing beam splitter 6. Again, the polarization state of the input beam I is preferably linearly polarized in parallel with the polarization axis of polarizer 24. The second component is reflected in polarizing beam splitter 6 by 90° to be directed along a third separate processing path H to be modulated.

A skew angle compensator in the form of a quarterwave retarder 26 processes the third component prior to reaching a third LCoS panel 28, at which the third component is modulated by selectively rotating the polarization state of desired parts of the beam through 90°. On reflection, desired parts of the third component are transmitted through polarizing beam splitter 6 and reflected from the reflective interface of dichroic beam splitter 8. Thus, desired parts of the first, second and third component beams are combined and directed along the fifth processing path E. At this point, the first and second components are orthogonally polarized, whereas the first and third components exhibit parallel polarization states. However, unwanted parts of the first, second and third beam components remain at this stage, due to the imperfect analyzing performance of each of the two beam splitters 4, 6. In particular, the analyzing performance of the beam splitter 4 when reflecting the desired components of the second component beam is more imperfect than the performance of the two analyzers 4,6 in transmitting the desired parts of the first beam component and the second beam component, respectively.

A further analyzing stage is provided at the output part of the device, by means of three separate post analyzers 30, 32 and 34. Each analyzer is in the form of a spectrally-selective polarizer plate. The first analyzer 30 is selectively active in the part of the spectrum corresponding to the wavelength range of the second spectral component, the second analyzer 32 is active in a spectral range corresponding to the wavelength range of the first component, and the third analyzer 34 is active in a spectral range corresponding to the wavelength range of the third component. Note that the analyzers 30, 32 and 34 may be arranged in any order.

As the desired parts of the first and second components are orthogonally polarized when output along the fifth processing path E, the first output analyzer 30 and the second output analyzer 32 have axes of polarization which are orthogonally arranged, such that the first output analyzer 30 has an axis of polarization which is parallel to that of the desired part of the second component, and the second output analyzer 32 has an axis of polarization which is parallel to the polarization state of the desired part of the first component. Furthermore, the third output analyzer 34 has an axis of polarization which is arranged parallel to that of the polarization state of the desired part of the third component, and is also parallel to the axis of polarization of the second output analyzer 32.

Accordingly, the radiation emerging from the device at the output beam O has been subjected to second-stage analysis, provided by the three separate spectrally selective analyzers 30, 32 and 34.

Note that in the output beam O the polarization states of different components of the beam differ. In one embodiment, further elements in the output part of the projection apparatus, for example the projection lens, include one or more additional polarizing elements, which act similarly across the whole spectrum. In this embodiment, the polarization direction of all of the three components are made parallel before reaching such additional polarizing elements by adding a further spectrally selective retardation plate to selectively rotate the second light beam component through 90° after passing through the three analyzers 30, 32 and 34.

FIG. 2 illustrates a further embodiment of the invention. In this embodiment, a similar arrangement of the elements shown in FIG. 1, other than the output analyzers 30, 32 and 34, is also used. Similar reference numerals are used in FIG. 2 for the common elements, and their description will not be repeated for the sake of brevity. In place of the three output analyzers 30, 32 and 34, a further polarization-sensitive stage of processing is provided by two processing elements 36 and 38. A spectrally selective retardation plate 36 selectively rotates the polarization state of the second component, such that the desired parts of the second component have a polarization state which is parallel to the polarization state of the desired part of the first and third components. Subsequently, an analyzer plate 38, which acts across the entire spectral range covered by the first, second and third components, is provided to analyze the first, second and third components together, to provide the second analyzing stage, thereby improving contrast in the output beam O. An advantage of this embodiment is that the output beam has all of the three components with the same state of polarization, so that if further polarizing components are used in the remainder of the apparatus, all of the three components may be similarly processed thereafter.

Each of the three cubic beam splitters 4, 6, 8 is preferably embodied in the form of glass cubic components. Each of the remaining components illustrated in FIGS. 1 and 2 is a laminar component. All of the components are bonded together, using an adhesive, in the arrangement shown in the Figures. In particular, the three cubic beam splitters 4, 6 and 8 are all bonded together to form a unitary block, and each of the LCoS panels and its associated laminar elements is bonded in place on the appropriate face of the cubic beam splitter. No air gap, nor any additional laminar films or other elements, are placed between the three cubic beam splitters 4, 6 and 8. The unitary block of the beam splitters provides a rigid and stable body to be used for mounting LCoS panels, thereby providing improved convergence of the imaging provided by the panels. By avoiding the positioning of the analyzers between the cubic beam splitters, and instead locating the analyzer(s) on an external face of the beam splitter arrangement, the device can be operated at high brightness levels without degrading the analyzer(s), because the analyzer(s) can be readily air-cooled. Furthermore, thermally induced stress birefringence is reduced.

In each embodiment described, the second-stage analysis is provided by a plurality of laminar elements including a polarization-sensitive element. In one embodiment, the polarization-sensitive element is a spectrally selective retardation plate. In this respect, the term “polarization-sensitive” is intended to include all types of elements which have a desired effect, including both polarization-based filtering and polarization rotation, on the polarization state of the beam, when arranged in the apparatus provided.

Herein the term “cubic beam splitter” is not intended to be limited to cubes with sides of equal length; the sides may have unequal lengths as desired, in particular when the LCoS panels are themselves rectangular.

The above embodiments are to be understood as illustrative examples of the invention. Further embodiments of the invention are envisaged. It is to be understood that any feature described in relation to one embodiment may also be used in other embodiments. Furthermore, equivalents and modifications not described above may also be employed without departing from the scope of the invention, which is defined in the appended claims.

1. An optical device for processing radiation, said device comprising:
a. radiation input means arranged to direct first and second spectral components along a first processing path (A) and to direct a third spectral component along a second processing path (B);
b. first polarization-selective reflective means (4) arranged to reflect the first spectral component and the second spectral component selectively in dependence on polarization states thereof, to direct said first and second components towards first and second radiation modulation means (18, 22), respectively, for modulation thereby and to direct the first and second components, after modulation, along a third processing path (C), said first and second components having different polarization states when travelling along said third processing path;
c. second polarization-selective reflective means (6) arranged to reflect the third component selectively in dependence on a polarization state thereof, to direct said third component towards third radiation modulation means (28), for modulation thereby and to direct the third component, after modulation, along a fourth processing path (D);
d. spectrally selective reflective means (8) arranged to process said first and second spectral components similarly when in different polarization states, and arranged to direct said first and second components and said third component along a fifth processing path (E); and
e. radiation output means (30, 32, 34; 36, 38) arranged to process radiation along said fifth processing path, said output means including spectrally selective polarization-sensitive means (30; 36) arranged to process said first and second components differently when in different polarization states.

2. An optical device as claimed in claim 1, wherein said polarization-sensitive means includes a first spectrally selective analyzer (30) with an axis of polarization arranged parallel to a polarization state of the second component.

3. An optical device as claimed in claim 2, wherein said polarization-sensitive means includes a second spectrally selective analyzer (32) with an axis of polarization arranged parallel to a polarization state of the first component and perpendicular to said axis of polarization of the first analyzer.

4. An optical device as claimed in claim 3, wherein said polarization-sensitive means includes a third spectrally selective analyzer (34) with an axis of polarization arranged parallel to a polarization state of the third component and perpendicular to said axis of polarization of the first analyzer.

5. An optical device as claimed in claim 1, wherein said polarization-sensitive means includes a spectrally selective polarization rotating element (36).

6. An optical device as claimed in claim 5, wherein said polarization-sensitive means includes an analyzer (38) arranged to process said first, second and third components similarly when in a similar polarization state.

7. An optical device as claimed in claim 1, wherein said input means comprises selectively reflective means (2) arranged to direct the first and second spectral components along the first processing path and to direct the third spectral component along the second processing path by selective reflection thereof.

8. An optical device as claimed in claim 1, wherein said device further comprises spectrally selective polarization rotating means (12) for rotating one of said first and second components in relation to the other of the first and second components, arranged to provide said first and second components with orthogonal polarization states when in said first processing path.

9. An optical device as claimed in claim 1, wherein said first and/or said second polarization-selective reflective means (4, 6) comprise a cubic polarizing beam splitter.

10. An optical device as claimed in claim 1, wherein said spectrally selective reflective means (8) comprise a cubic chromatic beam splitter.

11. An optical device as claimed in claim 9, wherein said cubic beam splitters are bonded together to form a unitary component.

12. An optical device as claimed in claim 9 wherein said cubic beam splitters are arranged without any analyzer elements arranged between said cubic beam splitters.

13. An optical device for processing radiation, said device comprising:
a. radiation input apparatus arranged to direct first and second spectral components along a first processing path and to direct a third spectral component along a second processing path;
b. a first polarization-selective reflective element arranged to reflect the first spectral component and the second spectral component selectively in dependence on polarization states thereof, to direct said first and second components towards first and second radiation modulation devices, respectively, for modulation thereby and to direct the first and second components, after modulation, along a third processing path, said first and second components having different polarization states when travelling along said third processing path;
c. a second polarization-selective reflective element arranged to reflect the third component selectively in dependence on a polarization state thereof, to direct said third component towards a third radiation modulation device, for modulation thereby and to direct the third component, after modulation, along a fourth processing path;
d. a spectrally selective reflective element arranged to process said first and second spectral components similarly when in different polarization states, and arranged to direct said first and second components and said third component along a fifth processing path; and
e. radiation output apparatus arranged to process radiation along said fifth processing path, said output apparatus including a spectrally selective polarization-active element arranged to process said first and second components differently when in different polarization states.
